(19) United States
(12) Patent Application Publication
(10) Pub. No.: US 2007/0056466 A1
(43) Pub. Date: Mar. 15, 2007

(54) Compound for the decoration of ceramics

(76) Inventor: Lucien Gustaaf Tinck, Sint Niklaas (BE)

Correspondence Address: Lucien G Tinck, Spoorweglaan 39 B1, Sint Niklaas, B 1900, BE

(21) Appl. No.: 10/563,146

(22) PCT Filed: Apr. 27, 2005
(86) PCT No.: PCT/BE05/00059

§ 371 Date: Oct. 23, 2006

(30) Foreign Application Priority Data
Apr. 30, 2004 (BE) 2004/0215

(51) Int. Cl. C09D 13/00

(52) U.S. Cl. 106/31.07; 106/31.08

(57) ABSTRACT

This invention relates to a compound for the decoration of ceramics and comparable materials with encloses a quantity of at least one inorganic pigment, a quantity of at least one glass-former and a quantity of at least one fusion element for the glass-former. The compound also contains a quantity of a non-polar material.

### DESCRIPTION OF THE INVENTION

### 1. Technical Domain

This invention relates to a compound for the decoration of ceramics, glass and comparable materials which encloses a quantity of at least one mineral pigment and a quantity of at least one glass-former and fusion element for the pigment as described in the exordium of the first conclusion.

### 2. TECHNICAL SITUATION

The decoration of a piece of work in unglazed ceramics or a ceramic vector by means of the application of a paint using colour slip, a substratum of a pigment and a superstratum of a coloured glaze, are on itself techniques which are known for a long time. The products used for the decoration are applied by means of a spout or a brush and they are fat free. Usually the ceramic piece of work will be, after the application of the decoration, covered with a layer of glaze and subsequently fired smooth at high temperature.

During the firing process the omnipresent minerals of the glaze will be bound with the ceramic vector and the applied decoration. The minerals melt together till either a transparent or non-transparent impervious layer or film is formed which blocks the environmental influences. Because the glaze rests on water, every contact with any fat must be avoided before firing the ceramic. The presence of any fat substance on the ceramic surface leads unavoidably to the repel of the colour slip and/or the glaze and eventually to flaws in the glaze surface which covers the ceramic. Therefore shall one, during the handling and the decoration of the unglazed ceramic, always wear gloves.

### 3. DIFFICULTIES ENCOUNTERED WITH THE ACTUAL TECHNICAL SITUATION

Referring to GB-A-793.359, a crayon is known for the decoration of ceramics which consists of a sintered compound of at least one metal bound and at least one glass-forming element and its appropriate smelter. The crayon has to be free of graphite, wax and lamp-black.

The aforecited crayon however has the disadvantage that it is not appropriate to be used with opaque and covering glazes because it will mask nearly completely the decoration applied with that crayon and the flux of adjacent glazes is not impeded.

Referring to DE-916.563, another crayon is known for the decoration of porcelain, which consists of a compound of one metal oxide, two minerals and a turpentine soluble wax. The compound does not contain a fusion element.

Consequently this crayon is not suited to be used on ceramics and comparable materials with a firing temperature below cone SK 7.

Hence there is need of a compound suitable for the decoration of ceramics that is able to be used with opaque and covering glazes. A compound which remains visible after firing, even with temperatures below cone SK 7.

### 4. DESCRIPTION OF THE INVENTION

This invention has as objective the creation of a compound for the decoration of ceramics that is able to be used with various kinds of glazes, included opaque and covering ones. Therefore the decoration which has been applied remains visible and is suited for all firing temperatures. This invention also delivers a compound that is suitable to be used with different kinds of glazes likewise opaque and covering ones, glass, earthenware and stoneware.

This purpose is achieved with a compound which has the technical characteristics as described in the first conclusion. The compound of this invention contains a quantity of a non-polar chemical and a mineral fusion element.

### 5. ADVANTAGES OF THE INVENTION

The inventor found that when a line or a drawing is applied with this crayon, a good bound is achieved on the surface of the ceramic piece of work. By means of the non-polar chemical the flux of the glazes over this barrier is impeded and there is only a slight risk for fluidity between the glazes during application. Hence, with this invention it is possible to combine adjacent glazes of different colours on a piece of work with a distinct separation between them, with only a slight risk for fluidity of the colours.

Therefore will the decoration, which is applied with the compound of this invention, remain visible even with either opaque or covering glazes. With this invention there is no need any more to use a mould as mechanical barrier. It is the decoration, applied with the compound of this invention, that acts as an intrinsic mould. Furthermore is it also possible, through this function as a barrier, to glaze vertical surfaces without using the so called ‘cloisonné’-barriers.

Furthermore the inventor also found out that the pigments together with the glass-former and the fusion element will fix onto the ceramic piece of work during relative high temperature firing. The non-polar chemicals which are present in the compound dissolve nearly completely above 5500° C.

### 6. DESCRIPTION OF THE INVENTION (SEQUEL)

In a first make-up this invention is characterized by the fact that the non-polar chemical is selected out of the group of saturated, unsaturated or cyclical hydrocarbons containing at least 5 carbon atoms which may be or may not be forked and may have one or more double bounds. This means: saturated or unsaturated fatty acids or compounds of two or more different fatty acids, fats or mixtures of two or more of the aforecited compounds. The craftsman has the possibility to chose out of the range of the known non-polar chemicals the right element, bearing in mind the other in the compound present components and/or the material or the substratum on which the mixture has to be applied.

In a second make-up of the invention, the non-polar chemical will be chosen out of a group of in decoration techniques frequently used non-polar materials, such as wax, paraffin, stearin, vybar and a compound of two or more of these elements.

The pigment which is used in this invention can be an inorganic pigment or a mineral pigment frit, or a compound of two or more of the aforecited pigments. These pigments show a good thermal stability and only a slight risk of decomposing during firing at high temperature. Pigments with a molecular bound with water, sulphites and sulphates, phosphates, acetates, chlorides and nitrates are to be avoided. When using pigments with a significant percentage of water there is always a risk that the quality of the decoration will deteriorate. Quick heating up a ceramic piece of work can provoke a sudden evaporation of the bounded water in the pigment to form local explosions resulting in pigment stains. Suitable colour forming materials are oxides and carbonates from among others: antimony, cadmium, chromium, iron, cobalt, copper, manganese, molybdenum, nickel, selenium, uranium, vanadium.

It is possible firing the decorated ceramic piece of work under specific conditions to induce in one or more of the aforecited pigments a change in colour. Such a change in colour may be induced by heating and by changing the oxidation level, through firing under reducing or oxidizing atmosphere.

The colour forming metal as such may be processed in the compound of this invention. On the other hand however, it is possible to use a colour forming metal which is sintered on a vector or which is encapsulated in a vector by means of fusion.

In a make-up of the compound of this invention, at least one glass-former is selected out of the group of alkaline and earth alkaline feldspars, calcium silicates, lead silicates, magnesium silicates, strontium titanates and titanites, zinc borates and a compound of two or more of these. Because of their alkaline character the aforecited glass-formers show a good affinity for the mineral pigments, which are present in the compound of this invention.

The craftsman has the possibility to select—taking in account the characteristics of the pigment used—the most appropriate glass-former in order to obtain the contemplated result at the desired temperature.

If it is the aim to apply a decoration that remains sharply edged even after firing, a glass-former shall be chosen with a higher melting-point than the melting-point of the glaze that will be applied afterwards. The pigment as such normally will not melt at the firing temperature. The fusion element however can be selected in such a way that the temperature at which the glass-former sinters will be lower than or will be almost equal with the firing temperature. With a given temperature, the fusion element shall therefore be selected that it will weaken and that it will show a slight fluidity. The pigment will then be absorbed in the weakened glass-former. It results in a decoration that initially consisted of a magnitude of discrete points applied on a rough surface, is being transferred into a continuous decoration. After firing, a line of discrete points will be transferred into a continuous line.

The aforecited fusion materials show good affinity onto the ceramic surface and affix on the surface during firing. After cooling down the weakened glass-former forms a closed layer that protects the pigment from environmental influences.

Usually a glass-former is selected with a melting-point which is higher than the melting-point of the glaze. In other words, higher than the temperature at which the glazed ceramic piece of work is fired. This gives the possibility to create a decoration that, during firing, will not mix with later on applied glazes. Such a composition shows an anti-flux character. This means that during the firing process of the glazed piece of work, the anti-flux character will counteract any interaction between the pigment of the composition and the glaze. Because pigments will not be incorporated in the glaze smelt when baked and therefore do not form part of it, the flux in the glaze smelt shall be thwarted and the decoration which was applied with this invention will remain visible even after the application and the firing of the covering glaze.

It is however possible that the composition of this invention contains extra materials which will act upon the melting-point of the glass-formers; preferably to lower it. Examples of such materials are frits of lead, calcium, sodium, potassium, lithium or compounds of two or more of these artificial compounds. The use of these materials admits a controlled blending of the glass-former with its coupled pigments to be formed on one of the aforecited ceramic applications. The craftsman is able to select out of the range of known mineral materials (fusion elements and glass-formers) the most compatible compound to obtain the desired result, taking in account the temperature at which the ceramic piece of work will be fired, the expected esthetical aspect and the pigments used.

By preference the pigment is selected as a frit. This means that the colour forming oxide is encapsulated in at least one glass-former. This ensures a stable application of the pigments that otherwise show minute colour stability when heated. Furthermore the toxic character of the pigments will be avoided.

The compound of this invention can be mould into a solid form like a crayon. These crayons are suitable to be used by the public at large and require minimal acquaintance with decoration techniques of ceramics. When the ceramic piece of work shows some coarseness, the crayon material will affix perfectly.

Thanks to the good bounding capacity of the compound, the craftsman disposes of a great array of techniques for the application of the glaze. The glaze may be applied by means of a brush; it is also possible to spray it on or to immerse it. The risk of damaging the applied decoration is very minute.

This invention also refers to a liquid make-up which contains at least one pigment and one glass-former for the pigment and a fusion element for the glass-former characterized by the fact that the composition also contains an amount of a non-polar material.

This invention relates likewise to a liquid compound, consisting of a quantity of at least one pigment, at least one fusion element and glass-former for this pigment, characterized by the fact that the compound contains a quantity of water bound with a non-polar element.

The compound of this invention can also be used in a fluid rested on water, bound to a non-polar element by means of an emulating agent.

The concentration of the compound in this invention in not critical and varies in a wide interval. In a possible make-up, the given ingredients are present in the given quantities: 5-20 units of weight (u.o.w.) pigment, 1-10 u.o.w. glass-former and 5-20 u.o.w. non-polar material. A crayon of this invention contains preferably 10-12 u.o.w. pigment, 2-5 u.o.w. glass-former and preferably 10 u.o.w. non-polar material. With such a composition a crayon will be obtained, which is adequate consistent to mark a rough surface. In a possible make-up with a firing temperature of about 1200° C., a crayon contains 10 u.o.w. pigment, 2 u.o.w. glass-former and fusion element, 8 u.o.w. paraffin and 0.1 u.o.w. stearin.

This invention also refers to a ceramic product with a decoration applied with the aforecited crayons or with one or more of the aforecited liquid compositions. This invention relates to every ceramic product, ceramic vector and every ceramic object or surface made out of clay, glass or related materials.

This invention also refers to the procedure for the production of a decorated ceramic with the use of the aforecited composition, the aforecited crayon and the aforecited liquid composition.

### 7. OPTIMUM MAKE-UP

An optimum make-up for a black coloured crayon with a firing temperature SK 02a can read as follows:

| | | |
|---|---|---|
| black pigment frit | 1200 | u.o.w. |
| smelt frit D208 | 350 | u.o.w. |
| kaolin | 50 | u.o.w. |
| bentonite | 10 | u.o.w. |

These ingredients are mixed in a molten compound of 1000 u.o.w. paraffin, 10 u.o.w. vybar and 5 u.o.w. stearin. This molten compound is cast in the form of a peg.

### 8. INDUSTRIAL APPLICATION

This invention is applicable in all industries connected with ceramics, glass and similar materials. It shall also be proven profitable for either the art industry or the individual artist.

1. A compound for the decoration of ceramics and similar material consisting of a quantity of at least one inorganic pigment and a quantity of at least one mineral glass-former, characterized by the fact that the composition also contains at least one fusion element for the glass-former and an amount of at least one non-polar material.

2. A compound according to conclusion #1, characterized by the fact that the non-polar material is selected out of the group of saturated, unsaturated or cyclical hydrocarbons containing at least 5 carbon atoms. This means: saturated or unsaturated fatty acids or compounds of two or more different fatty acids, fats or mixtures of two or more of the aforecited compounds.

3. A compound according to conclusions #1 or #2, characterized by the fact that a non-polar material is selected out of the group of wax, paraffin, stearin, vybar and a compound of two or more of these elements.

4. A compound according to conclusions #1 till #3, characterized by the fact that the pigment is from inorganic or mineral origin.

5. A compound according to conclusions #1 till #4, characterized by the fact that it contains a quantity of at least one glass-former selected out of the group of clay minerals such as feldspars, aluminium silicates, calcium silicates, boron silicates, titanites and compounds of two or more of these elements.

6. A compound according to conclusions #1 till #5, characterized by the fact that at least one mineral fusion element for the glass-former is selected out of the group with a alkaline forming character, such as: lithium compounds, sodium compounds, potassium compounds and those with a weak alkaline character, such as: magnesium oxide, calcium oxide, zinc oxide, barium oxide, lead oxide either as a natural or synthetized compound with acid forming and/or amphotere oxides.

7. A compound according to conclusions #1 till #6, characterized by the fact that the pigment is encapsulated in at least one glass-former.

8. A compound according to conclusions #1 till #7, characterized by the fact that it contains 5-20 u.o.w. pigment, 1-10 u.o.w. glass-former and 5-20 u.o.w. non-polar material.

9. A compound according to conclusions #1 till #8, characterized by the fact that it contains one or more of fusion elements to influence the melting-point of the glass-former.

10. A compound according to conclusion #9, characterized by the fact that it contains one or more fusion elements selected out of the group of minerals with a alkaline character as aforecited in conclusion #6.

11. A crayon for the decoration of ceramic products according to the compounds mentioned in conclusions #1 till #10.

12. A compound according to conclusions #1 till #9, characterized by its liquid make-up, containing a quantity of water.

13. A compound according to conclusion #12, characterized by the fact that it contains a quantity of an emulgating agent.

14. A ceramic product with a decoration, produced with a compound according to one of the conclusions #1 till #10, a crayon according to conclusion #11 or the compound according to conclusions #12 and #13.
